(19) United States
(12) Patent Application Publication
(10) Pub. No.: US 2013/0162221 A1
(43) Pub. Date: Jun. 27, 2013

(54) Direct Communications System for Charging Electric Vehicles

(71) Applicants: Kevin M. Jefferies, Raleigh, NC (US); Benjamin W. Edwards, Knightdale, NC (US); Matthew L. White, Raleigh, NC (US); Konstantin A. Filippenko, Raleigh, NC (US)

(72) Inventors: Kevin M. Jefferies, Raleigh, NC (US); Benjamin W. Edwards, Knightdale, NC (US); Matthew L. White, Raleigh, NC (US); Konstantin A. Filippenko, Raleigh, NC (US)

(73) Assignee: Schneider Electric USA, Inc., Palatine, IL (US)

(21) Appl. No.: 13/335,032

(22) Filed: Dec. 22, 2011

(51) Int. Cl. H02J 7/04; G08B 5/22

(52) U.S. Cl. 320/155; 340/1.1; 340/6.1

(57) ABSTRACT

An Electric Vehicle is equipped to communicate its state of charge and other vehicular information to AC-charging Electric Vehicle Supply Equipment which can present and manage charging options based on the state of charge information and user selected options. An array of Electric Vehicle Supply Equipment may be managed utilizing the state of charge information from a plurality of Electric Vehicles connected to the array.

### BACKGROUND OF THE INVENTION

1. Field of the Invention

The present invention deals generally with Electric Vehicles (EV) charging from standard USA alternating current (AC) Electric Vehicle Supply Equipment (EVSE) such as standard residential 120/240 volt service. Details of a current standard for such charging may be found in Society of Automotive Engineers (SAE) standard no. J1772. SAE J1772 is cited by way of example and illustration, and is not intended to limit the present invention. An EV is considered to be a vehicle with electric motors and batteries rechargeable from a power source outside the EV, to supply motive force, whether the vehicle is a plug-in hybrid or solely electric. An EVSE is considered to be an AC-based charging station for delivery of AC power to the EV, typically although not necessarily with a charging cable for the EV, whether it has one or multiple cables. An EVSE array includes any networked plurality of charging apparatus including multiple cables connected to a common unit or multiple units.

2. Discussion of the Known Art

Today, few if any standards exist for EV to EVSE communication. Battery and charging management is done by EV electronics. Charging stations thus cannot conveniently acquire vehicle information, such as the state of electrical storage battery charge, often called State of Charge (SOC) of the EV, that is required to estimate charging time (time until full charge or other specific level of charge), or the cost of charge.

An intelligent charging decision, whether by the EV operator or the EVSE should require knowing the current state of charge on the EV and the charging rate or specific time of completion desired by the EV operator. Indeed, many desired or beneficial functions are not possible or widely available due to the lack of shared data between the EV and the EVSE. Customers may desire knowing the charging completion time, or selecting the time of vehicle availability for charging, based on charging parameters such as the SOC, electricity rates, and resulting cost of charge. Customer desires for charging the EV will vary based on multiple parameters. For example, a commuter returning home for the evening may desire to only guarantee vehicle availability the next morning, and charge the vehicle at as low of cost as possible. Without knowing the SOC and amount of charge needed, the EVSE cannot coordinate this desire with the electricity rate schedule.

Also, existing EVSE/EV infrastructure does not allow the EVSE to extract information useful for self-diagnosis or troubleshooting the EVSE unit. With information available from the EV, the EVSE can verify the proper functioning of the cable or other system or internal components. For example, the EVSE can detect that when the charging cable is properly connected and supplying charging power to the EV, the SOC of the EV increases accordingly, or that the incoming voltage and current at the EV match the expected values provided by the EVSE. Also, without knowledge of the SOCs on the EVs being charged, the coordination of multiple EV charging operations networked at one installation can only be done based on current capacity utilization, thus excluding functionality based on SOC information. For example, while charging two cars simultaneously, it is not possible to balance the capacity distribution to prioritize the car with a lower SOC, because the SOC information is unknown to the EVSEs.

There now exist expensive or exotic means for extracting SOC information from the EV namely: cellular link telematic systems (e.g. On*Star, CARWINGS); the in-vehicle charge display; and direct wire links such as exist in high power DC chargers (CHAdeMO). However, each of these has inherent drawbacks. A cellular link requires the EVSE to interface through some communications means to the vehicle manufacturers' servers, necessitating an expensive radio or network connection. Use of the in-vehicle display provides limited data to the customer and requires manual data entry into the EVSE by the user, or a manual calculation by the user based on the SOC not coordinated with the EVSE. The direct wire link exists only on high power DC charger interfaces, which excludes the most ubiquitous type of EV charger, i.e. AC residential chargers and public stations. Standards for EV to EVSE communications for AC chargers are under development, but are not available today. Further, the new standards will not address any of the problems mentioned above for existing EVs built before the adoption of these future standards.

### SUMMARY OF THE INVENTION

In order to address the above shortcomings, the present invention provides for direct communications between EVs and AC-charging EVSEs and a system retrofitable to existing EV/EVSE AC charging infrastructure. Aspects of the invention may at least allow for control of charging time based on communication of the SOC for the EV, or for diagnostics of EVSE function by using information communication from the EV, or both.

In some aspects of the invention, the coordination of multiple EVSE units at one installation can be done based on current capacity utilization and prioritization based on SOC information. For example, while charging two cars simultaneously, it will be possible to balance the capacity distribution to prioritize the car with a lower SOC, because the SOC information is now known to the EVSEs or any coordination system. Further aspects of the invention may allow for charging prioritization and energy management including optimal capacity utilization in an array of multiple chargers.

One or more aspects of the present invention may provide a direct communications system between EVs and AC-charging EVSEs e.g. under SAE J1772. EVs can be equipped with an EV transmitter unit adapted to connect to an existing OBD2 diagnostic connector of the vehicle. The EV transmitter unit may transmit vehicle data including at least one of: the Vehicle Identification Number (VIN), SOC, time to charge, charge voltage, charge current, and charging handle (cable lock) state, from the vehicle's CANBUS connection on the OBD2 diagnostic connector. The EV transmitter unit can be equipped with communications means such as a low power wireless transmitter, e.g. BLUETOOTH, for transmitting vehicle data to the EVSE, which will be set up to read and interpret such information and respond accordingly.

The EVSE will preferably further have a Human Machine Interface (HMI), or link to an HMI, to allow the EV operator to make charging selections based on time required to charge, including at least one of a desired time of vehicle availability, level of charging, and a cost for charging; and a processor unit and all associated computer hardware to calculate and manage charging functions accordingly.

Operator selectable charging options might include a percentage amount of charge; a time to completion of charge, whether an elapsed time or by a specific time; a level of charge, e.g. high or low; a total cost (in dollar amount), or priority of charging by electricity rate, e.g. present rate, lowest rate, lowest between X-Y times. Further aspects of the invention may include utilizing the direct communications to provide the ability to inform operators how much the cost of their selected charging options will be before authorization.

### BRIEF DESCRIPTION OF THE DRAWINGS

The foregoing and other advantages of the present disclosure will become apparent upon reading the following detailed description and upon reference to the drawings of which:

FIG. 1 is an EV and EVSE with a direct low power wireless link for transmitting vehicle data to the charging unit including illustrated examples of locations for the HMI (EVSE, in-car, or smart phone/mobile computing device).

FIG. 2 is an EVSE Human Machine Interface display for the present system.

FIG. 3 is an exemplary EV and EVSE array.

### DETAILED DESCRIPTION OF A PREFERRED EMBODIMENT

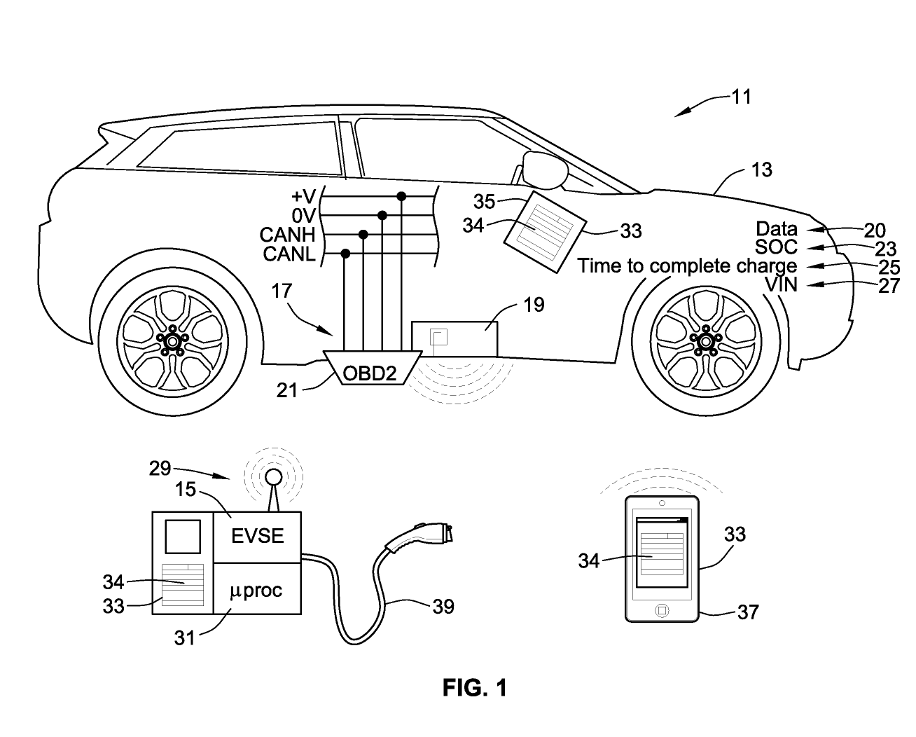

FIG. 1 illustrates a direct communications system 11 between an EV 13 and an AC-charging EVSE 15. As discussed above, the present invention is especially well suited for the present infrastructure of EV 13 charging in the US which is an AC-based SAE standard with two charging levels. As known in the art all US cars and light trucks have been equipped with a OBD-II (sometimes “OBD2”) sensor and data bus system 17 which has been mandatory since 1996 in US on all cars and light trucks. The OBD2 system 17 operates on the well known CANBUS protocol. The EV 13 is equipped with an EV transmitter unit 19 with a connection 21 adapted to connect to the existing data bus 17 of the vehicle 13 and which reads vehicle data including at least one of: SOC 23, time to charge completion 25, charge voltage, charge current, VIN 27, and cable lock state, and is equipped with a low power wireless transmitter 19 such as BLUETOOTH for transmitting vehicle data. Such transmitter units at this writing are commercially available such as for example a Soliport ELM 327 Bluetooth OBDII (OBD2) Diagnostic Scanner, available from the Amazon. Webstore (amazonwebstore.com).

The EVSE 15 is equipped with a low power wireless receiver 29 for receiving vehicle data 20 from the EV transmitter unit 19. It will be appreciated that the EVSE 15 is a stationary device already attached to the electrical grid. Other communication, e.g., through the grid or other means as deemed necessary or desirable, are considered within the ordinary skill in the art. Such communications may advise the EVSE 15, or a central controller therefore if said EVSE 15 is in an array, of information such as present and near term electricity rates, or provide verification of consumer credit associated with the VIN 27 transmitted in the OBD2 data 20 or the like. In some aspects of the invention the receiver 29 may be a transceiver for receiving and sending information. The EVSE 15 is further equipped with a processor unit 31 and a human machine interface 33. After receiving the SOC 23 from the EV 13 via the wireless link 19 and presenting charging options which allow the EV 13 operator to make charging selections, including at least one of a desired time of charged vehicle availability, level of charging, and charging at a selected cost or electricity rate, the processor 31 can calculate time to charging functions based on the EV's SOC and the operator's selected options and provide feedback to the operator on the display for verification or change. The processor 31 may also be suitably adapted to control the charging functions of the EVSE 15.

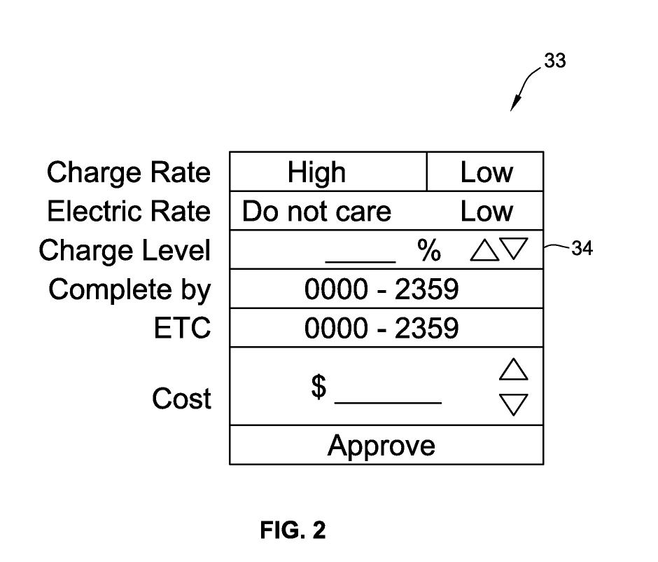

The human machine interface 33 (hereinafter simply “HMI”) can for example present the grid of options 34 shown in FIG. 2, for operator selection. It will be appreciated that other displays could be utilized such as the in-car display 35 or a smart phone application 37 if the mounting or retrofitting of a HMI is always not considered practical for the EVSE 15. After the operator has made selections, the EVSE 15 processor will have the ability to calculate, and the HMI 33 can inform, operators how much the cost of their selected charging options will be before authorization.

In other aspects of the present invention, because there is established a direct link between the OBD2 information of the EV 13 and the EVSE 15, the EVSE 15 can be configured to use real time EV 13 charging information such as comparing the incoming voltage and current at the EV 13 to the expected values provided by the EVSE 15, to diagnose the charging process functionality. With the information available from the EV 13, the EVSE 15 can verify the proper functioning of the cable or other system or internal components. For example, the EVSE 15 can detect that when the charging cable 39 is connected to the power source and the EV, that the SOC of the EV 13 increases accordingly, or that the incoming voltage and current at the EV 13 match the expected values provided by the EV 13.

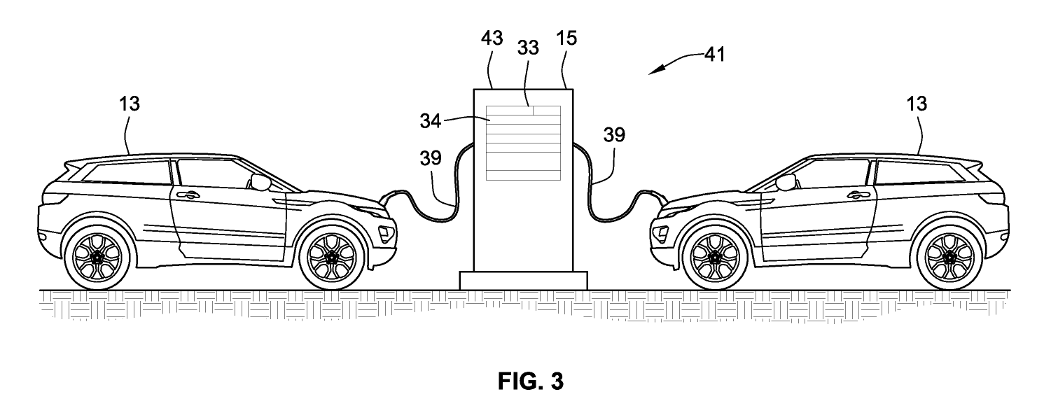

As seen in FIG. 3, an array 41 of networked EVSEs, here with two cables 39 on a single stand 43 is shown for charging of multiple vehicles with the EVSE 15 controlling the charging. Such an array 41 for example could be something as simple as charging two EVs in a residence's garage or managing a larger number of EVSE 15 charging operations in a commercial space. The array operations can be coordinated for at least one of charging prioritization, energy management and maximum electrical capacity utilization, based on SOC information among the EVs electrically connected to said EVSEs 15. All of this is made possible by the EVSE knowing the EVs' state of charge.

In embodiments of the invention where the EVSE 15 can send information to other receptive devices it is envisioned that other HMIs such as an in home display would allow a charging routine to be set up from inside a residence, through the utility grid or house wiring, or via internet communications where charging information and selection interface can go to any web-enabled device.

According to the above discussion a method of direct communication between EVs 13 and AC-charging EVSEs 15 might thus include the steps of equipping the EV with a low power wireless transmitter attached to the OBD2 diagnostic connector for transmitting OBD2 vehicle data including at least SOC data of the EV, equipping the EVSE with a low power wireless receiver for receiving OBD2 vehicle data transmitted from the EV; providing the EVSE with a processor and any associated computing hardware such as memory; for calculating one or more of a plurality of charging options including at least one of charge time options and charge cost options for charging the EV batteries, based upon the vehicle data received; displaying said charging options for selection by an EV operator; allowing the EV operator to select desired charging options; and charging the EV according to said selected options. The processor and HMI may be equipped for calculation and display, respectively, of the estimated cost of charge based on the selected options and allow the operator to confirm charging after the cost display. Such calculations are considered to be within the ordinary of the art and can be left to the individual implementation of the designer.

Displaying of operator selectable options may include choices of the percentage of charge at completion and the time to charge completion. The time to charge completion option may include at least one of an elapsed time or a specific time and might be displayed as an Estimated Time to Completion (ETC) as shown in FIG. 2. Other selectable options may include an enterable or selectable total cost to charge completion. It is further desirable that the operator or the EVSE be given an opportunity to select among variable electricity cost rates which can vary throughout the day.

Several aspects or embodiments of a method according to the present invention may further comprise transmitting the VIN from the EV and verifying the VIN at the EVSE not only so that the EVSE will know the appropriate manufacturers codes for the vehicle data; but VIN or other vehicle identification means could also be used for various types of charge authorization such as account or credit verifications, etc.

Having thus described a system for direct communication between an EV and EVSE to communicate the EV's state of charge and other vehicular information for use by the EVSE for the benefit of the operator, the EVSE operations, or both, it will be appreciated that many variations thereon may occur to the artisan upon an understanding of the present invention, which is therefore to be limited only by the appended claims.

1. A direct communications system between EVs and AC-charging EVSEs comprising:
a) an EV transmitter unit with a connection adapted to connect to an existing data bus of the vehicle and which reads vehicle data including at least one of: SOC, time to charge, charge voltage, charge current, VIN, and proximity (cable lock) state,
and is equipped with a low power wireless transmitter for transmitting vehicle data to an/the EVSE;
b) an EVSE:
equipped with a low power wireless receiver for receiving vehicle data from the EV transmitter unit
and a processor unit to calculate time to charging functions based on the EV's SOC, and allow the EV operator to make charging option selections.

2. The direct communications system between EVs and AC-charging EVSEs according to claim 1 wherein the charging options include at least one of a desired time of charged vehicle availability, percentage level of charging, and charging at a selected cost or electricity rate.

3. The direct communications system between EVs and AC-charging EVSEs according to claim 1 wherein the databus includes an OBD2 diagnostic connector.

4. The direct communications system between EVs and AC-charging EVSEs according to claim 3 wherein the data bus operates on the CANBUS protocol.

5. The direct communications system between EVs and AC-charging EVSEs according to claim 1 further including:
for a human machine interface making said charging information available to the EV operator.

6. The direct communications system between EVs and AC-charging EVSEs according to claim 5 wherein the display is provided with the EVSE.

7. The direct communications system between EVs and AC-charging EVSEs according to claim 5 wherein the display is provided with the EV.

8. The direct communications system between EVs and AC-charging EVSEs according to claim 5 wherein the display is provided in a smart phone application.

9. The direct communications system between EVs and AC-charging EVSEs according to claim 1 further comprising:
the EVSE being configured to use real time EV charging information to diagnose charging process functionality.

10. The direct communications system between EVs and AC-charging EVSEs according to claim 1 further including:
an array of networked EVSEs for charging of multiple vehicles with the EVSE control; said array operations being coordinated for at least one of charging prioritization, energy management and maximum capacity utilization, based on SOC information among the EVs electrically connected to said EVSEs.

11. The direct communications system between EVs and AC-charging EVSEs according to claim 1 further including:
the ability to inform operators how much the cost of their selected charging options will be before authorization.

12. A method of direct communication between EVs and AC-charging EVSEs including the steps of:
a. equipping the EV with a low power wireless transmitter attached to the OBD2 diagnostic connector for transmitting vehicle data including at least SOC data of the EV,
b. equipping the EVSE with a low power wireless receiver for receiving vehicle data transmitted from the EV,
c. providing the EVSE with a processor for calculating one or more of a plurality of charging options including at least one of charge time options and charge cost options for charging the EV batteries, based upon the vehicle data received;
d. displaying said charging options for selection by an EV operator;
e. allowing the EV operator to select desired charging options; and
f. charging the EV according to said selected options.

13. The method according to claim 12 further comprising displaying the estimated cost of charge based on the selected options.

14. The method according to claim 12 wherein said displaying of options includes:
the percentage of charge at completion and
the time to charge completion.

15. The method according to claim 14 wherein said the time to charge completion includes at least one of an elapsed time or a specific time.

16. The method according to claim 12 wherein said displaying of options includes:
a selectable total cost to charge completion.

17. The method according to claim 12 wherein said displaying of options includes:
a selectable electricity cost rate.

18. The method according to claim 12 further comprising transmitting the VIN to the EVSE.

19. The method according to claim 12 further comprising:
managing the charging of multiple vehicles connected to an array of networked EVSEs, said charging being coordinated for at least one of charging prioritization, energy management and maximum capacity utilization, based on SOC information among the EVs electrically connected to said EVSEs.
